(19) United States
(12) Patent Application Publication
(10) Pub. No.: US 2015/0019629 A1
(43) Pub. Date: Jan. 15, 2015

(54) Just-in-Time Dereferencing of Remote Elements in Dynamic Adaptive Streaming over Hypertext Transfer Protocol

(71) Applicant: Futurewei Technologies, Inc., Plano, TX (US)

(72) Inventors: Alexander Giladi, Princeton, NJ (US); Xin Wang, Rancho Palos Verdes, CA (US)

(21) Appl. No.: 14/331,963

(22) Filed: Jul. 15, 2014

Related U.S. Application Data
(60) Provisional application No. 61/846,412, filed on Jul. 15, 2013.

(51) Int. Cl. H04L 29/06; H04L 29/08

(52) U.S. Cl. CPC H04L 65/601; H04L 67/02; H04L 67/42
USPC 709/203

(57) ABSTRACT

A method of dereferencing by a client in a network implementing Dynamic Adaptive Streaming over Hypertext Transfer Protocol (HTTP) (DASH), the method comprising receiving a first period of streaming content containing a message instructing the client to retrieve an updated media presentation description (MPD) and containing an indicator indicating a location from which the client is to retrieve the updated MPD, retrieving the updated MPD, and dereferencing a link in the updated MPD, wherein the link indicates a location of content to be streamed in a second period of streaming content described in the updated MPD, and wherein the client performs the dereferencing at a time before an end of the first period of streaming content that is twice a length of a minimum buffer time.

### CROSS-REFERENCE TO RELATED APPLICATIONS

The present application claims priority to U.S. Provisional Patent Application No. 61/846,412 filed Jul. 15, 2013 by Alexander Giladi and entitled “Just-in-Time Dereferencing of Remote Elements in Dynamic Adaptive Streaming over Hypertext Transfer Protocol,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Video content, audio content, or other content may be streamed over the internet from a content server to one or more clients. In some cases, the content that is streamed may have been stored on the server at some time prior to being streamed. In other cases, such as the streaming of a live sporting event, the server may stream the content substantially simultaneously with receiving the content from a recording device. A client receiving the content may play back the content substantially simultaneously with receiving the content from the server, as opposed to the case of a simple download, where the client may save the content to a memory location and then play back the content after all of the content has been received.

### SUMMARY

In one embodiment, the disclosure includes a method of data streaming in a network implementing Dynamic Adaptive Streaming over Hypertext Transfer Protocol (HTTP) (DASH). The method comprises preparing, by a network element, a first period of streaming content containing a message instructing a client to retrieve an updated media presentation description (MPD) and transmitting the first period of streaming content to the client.

In another embodiment, the disclosure includes a method of dereferencing by a client in a network implementing DASH. The method comprises receiving a first period of streaming content containing a message instructing the client to retrieve an updated MPD and containing an indicator indicating a location from which the client is to retrieve the updated MPD; retrieving the updated MPD; and dereferencing a link in the updated MPD, wherein the link indicates a location of content to be streamed in a second period of streaming content described in the updated MPD, and wherein the client performs the dereferencing at a time before an end of the first period of streaming content that is twice a length of a minimum buffer time.

In another embodiment, the disclosure includes a method of performing dynamic just-in-time dereferencing of a link to adaptive streaming content. The method comprises following a combination of dynamic multi-period dereferencing procedures and static just-in-time dereferencing procedures, wherein an MPD describing the content contains remote period elements, and wherein an update of the MPD is triggered by a MPD Validity Expiration event, and wherein compliance with the dynamic just-in-time dereferencing is signaled by a @profiles attribute with the value http://dashif.org/guidelines/adin/dynamic#Jit.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an adaptive streaming video content delivery system according to an embodiment of the disclosure.

FIG. 2 is a schematic diagram of a network element according to an embodiment of the disclosure.

FIG. 3 is a schematic diagram of the delivery of an updated manifest document in an adaptive streaming video content delivery system according to an embodiment of the disclosure.

FIG. 4 is a schematic diagram of an adaptive streaming dereferencing system according to an embodiment of the disclosure.

FIG. 5 is a flowchart illustrating a method for data streaming in an adaptive streaming system according to an embodiment of the disclosure.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Adaptive streaming has been proposed as a mechanism to meet increasing demands for internet bandwidth. In adaptive streaming, data to be streamed over the internet exists in a plurality of different versions, which may be referred to as representations. Each version may be compressed to a different size and transmitted at a different rate. The version that is streamed to a given client at a given time may be adaptively selected by the client based on network conditions at that time, the client's capabilities, and/or other factors. Video content may be streamed in a plurality of time periods where, for example, a first period contains a first portion of the main content, a second period contains an advertisement, and a third period contains a second portion of the main content. When a client requests streaming video content, a content server may send the client a manifest document containing a plurality of Uniform Resource Locators (URLs) indicating locations from which the client may retrieve the content for each of the periods.

Disclosed herein are mechanisms whereby a video content server may insert a message into a segment of streamed video content instructing a client to retrieve an updated manifest that includes a description of a new period that was not described in a manifest previously available to the client. The updated manifest may indicate that the new period is to begin after the transmission of the message. The updated manifest may also include a reference to the location of the content, such as an advertisement, that is to be played in the new period. In some cases, the new period may be a dynamic period. That is, the starting time of the new period may not have been known at the time the manifest previously available to the client was prepared. When the starting time of the new period becomes known, that time may be included in the updated manifest. The embodiments disclosed herein may also specify a time when a link to the content in the new period is to be dereferenced.

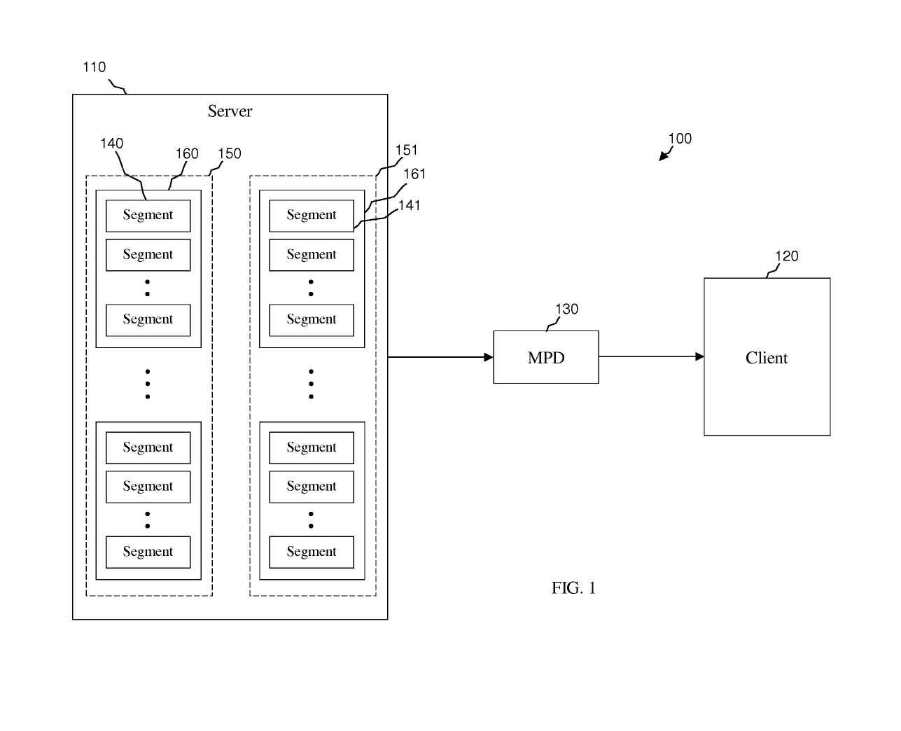

FIG. 1 is a schematic diagram of an embodiment of an adaptive streaming video content delivery system 100. Multiple different technologies and protocols are available for video streaming, and there may be multiple types of adaptive video formats. The discussion hereinafter will focus on a content delivery platform known as DASH (Dynamic Adaptive Streaming over Hypertext Transfer Protocol (HTTP)), but it should be understood that similar considerations may apply to other video content delivery platforms. The system 100 may include a server 110 or a similar component, which may hold one or more DASH media presentations. A media presentation may include multiple versions of a piece of video content, such as a movie, a television program, or a recorded sporting event. A client 120 may receive video content transmitted from the server 110.

The different versions of video content on the server 110 may comprise a plurality of data segments 140 that may be configured such that each version of the content may be transmitted to the client 120 at a different transmission rate. A video stream using DASH may start with the transmission of a manifest called a Media Presentation Description (MPD) 130 from the server 110 to the client 120. The MPD 130 may include a list of URLs and a description of the decomposition of the video stream into segments 140 that each correspond to a specific time frame in the video stream and a specific encoding. Thus, a video may be represented in a time dimension and a rate dimension. The client 120 may measure the throughput achieved in downloading a segment 140 corresponding to a time window and may then select an appropriate transmission rate and associated encoding for the next time window. The client 120 may thus be reactive to variations in the channel quality on the path between the client 120 and the server 110.

The MPD 130 may comprise information for one or more periods. Each period may comprise one or more adaptation sets 150. Each adaptation set 150 may comprise one or more representations 160. Each representation 160 may comprise one or more segments 140. A period may comprise timing data and may represent a content period during which a consistent set of encoded versions of the media content is available (e.g., a set of available bit rates, languages, captions, subtitles etc., that do not change). An adaptation set 150 may represent a set of interchangeable encoded versions of one or more media content components. For example, a first adaptation set 150 may comprise a main video component, a second adaptation 151 set may comprise a main audio component, and a third adaptation set (not shown) may comprise captions. An adaption set 150 may also comprise multiplexed content, such as combined video and audio. A representation 160 may describe a deliverable encoded version of one or more media content components, such as an International Organization for Standardization (ISO) Base Media File Format (ISO-BMFF) version or a Moving Picture Experts Group (MPEG) version two transport system (MPEG-2 TS) version. A representation 160 may describe, for example, any codecs, encryption, and/or other data for presenting the media content.

The client 120 may dynamically switch between representations 160 and 161 based on network conditions, device capability, user choice, and/or other factors. Such dynamic switching may be referred to as adaptive streaming. Each segment 140 may comprise media content data, may be associated with a URL, and may be retrieved by the client 120, e.g., with an HTTP GET request. Each segment 140 may contain a pre-defined byte size (e.g., 1000 bytes) and/or an interval of playback time (e.g., two or five seconds) of the media content. A segment 140 may comprise the minimal individually addressable unit of data that can be downloaded using URLs advertised via the MPD 130. The periods, adaptation sets 150, representations 160, and/or segments 140 may be described in terms of attributes and elements, which may be modified to modify the presentation of the media content by the client 120.

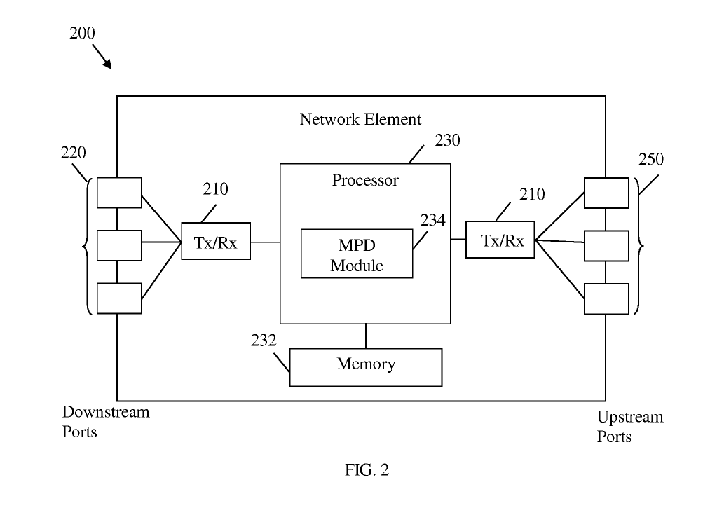

FIG. 2 is a schematic diagram of an embodiment of a network element (NE) 200 that may be suitable for implementing one or more embodiments of systems, methods, and schemes disclosed herein. For example, the NE 200 may act as the server 110 or the client 120 of FIG. 1. The NE 200 may be implemented in a single node, or the functionality of the NE 200 may be implemented in a plurality of nodes. One skilled in the art will recognize that the term NE encompasses a broad range of devices of which NE 200 is merely an example. NE 200 is included for purposes of clarity of discussion, but is in no way meant to limit the application of the present disclosure to a particular NE embodiment or class of NE embodiments. At least some of the features and methods described in the disclosure may be implemented in a network apparatus or component such as an NE 200. For instance, the features/methods in the disclosure may be implemented using hardware, firmware, and/or software installed to run on hardware.

As shown in FIG. 2, the NE 200 may comprise transceivers (Tx/Rx) 210, which may be transmitters, receivers, or combinations thereof. A Tx/Rx 210 may be coupled to a plurality of downstream ports 220 for transmitting and/or receiving data from downstream entities. A Tx/Rx 210 may also be coupled to a plurality of upstream ports 250 for transmitting and/or receiving data from upstream entities. A processor 230 may be coupled to the Tx/Rxs 210 to process the data and/or determine which nodes to send data to. The processor 230 may include an MPD module 234 for performing the functions described herein related to an MPD. The processor 230 may comprise one or more multi-core processors and/or memory devices 232, which may function as data stores, buffers, etc. The processor 230 may be implemented as a general processor or may be part of one or more application specific integrated circuits (ASICs) and/or digital signal processors (DSPs). The downstream ports 220 and/or upstream ports 250 may contain electrical and/or optical transmitting and/or receiving components.

It is understood that by programming and/or loading executable instructions onto the NE 200, at least one of the processor 230, the MPD module 234, the Tx/Rxs 210, the memory 232, the downstream ports 220, and/or the upstream ports 250 are changed, transforming the NE 200 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

It should be understood that any processing of the present disclosure may be implemented by causing a processor (e.g., a general purpose central processing unit (CPU) inside a computer system) in a computer system to execute a computer program. In this case, a computer program product can be provided to a computer or a mobile device using any type of non-transitory computer readable media. The computer program product may be stored in a non-transitory computer readable medium in the computer or the network device. Non-transitory computer readable media may include any type of tangible storage media. Examples of non-transitory computer readable media include magnetic storage media (such as floppy disks, magnetic tapes, hard disk drives, etc.), optical magnetic storage media (such as magneto-optical disks), compact disc read-only memory (CD-ROM), compact disc recordable (CD-R), compact disc rewritable (CD-R/W), digital versatile disc (DVD), Blu-ray (registered trademark) disc (BD), and semiconductor memories (such as mask ROM, programmable ROM (PROM), erasable PROM, flash ROM, and random access memory (RAM)). The computer program product may also be provided to a computer or a network device using any type of transitory computer readable media. Examples of transitory computer readable media include electric signals, optical signals, and electromagnetic waves. Transitory computer readable media can provide the program to a computer via a wired communication line (e.g., electric wires or optical fibers) or a wireless communication line.

As mentioned above, video content may be stored on a server for streaming at a later time. If advertisements are to be interspersed among the main content, the times when the advertisements are to be played may be known at the time the MPD for the content is prepared. In such a case, the MPD may include the starting time or the length of each piece of main content and each advertisement. For example, the MPD may describe a first main content period with a known starting time or known length, to be followed by a period with an advertisement with a known starting time or known length, to be followed by a second main content period with a known starting time or known length. The MPD may include a URL specifying the location of the content to be played in each period or a link to a location where such a URL may be found.

In other cases, content is not stored on a server prior to being streamed but is instead streamed at substantially the time the content is recorded. Such live streaming may be employed, for example, in the streaming of a live sporting event. In such cases, the times when advertisements are to be played may not be known before the event begins but may instead arise based on circumstances in the event, such as when a referee calls a time-out. It may not be possible to generate an MPD prior to such an event to describe the starting times of the periods when advertisements are to occur.

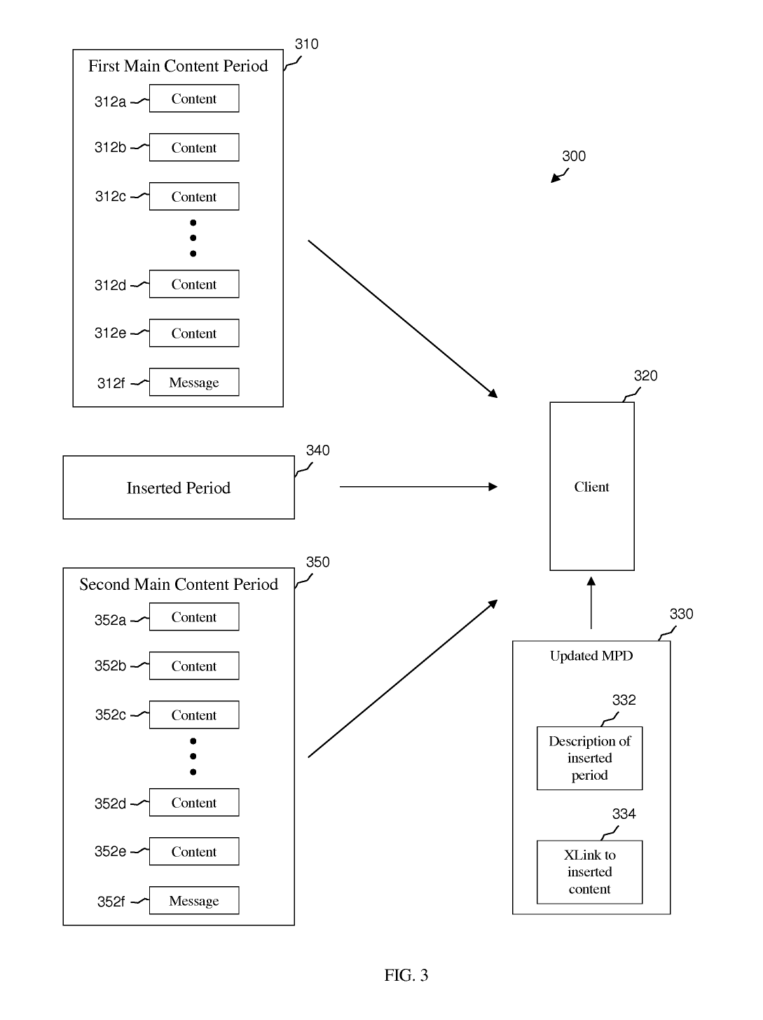

Embodiments of the present disclosure provide mechanisms for the insertion of periods into streaming content when the starting times of the periods are not known prior to the commencement of the streaming. FIG. 3 illustrates a system 300 in which an advertisement or other secondary content may be inserted into a main stream of content at a time that was not known when the streaming began. A first main content period 310 may be prepared and transmitted by a server, such as the server 110 of FIG. 1. In an embodiment, the first period 310 may contain a plurality of segments 312, all but one of which may contain streaming content such as video and/or audio content. The last segment 312f transmitted in the period 310 may contain a message inserted by the server rather than video or audio content. The message in the last segment 312f may instruct a client 320, which may be substantially similar to the client 120 of FIG. 1, to retrieve an updated MPD 330. The message may include a URL or other indicator informing the client 320 where the updated MPD 330 may be found.

The updated MPD 330 may include a description 332 of content in a newly inserted period 340 that was not described in an MPD previously available to the client 320. The description 332 may indicate that the inserted period 340 is to begin substantially immediately after the end of the transmission of the first period 310 of main content. The updated MPD 330 may also include a link 334 indicating a location where the content that is to be played in the inserted period 340 may be found. In some cases, the content that is played in the inserted period 340 may be an advertisement.

The message in the last segment 312f of the first main content period 310 may inform the client 320 that a second main content period 350 is to begin when the inserted period 340 ends. The last segment 352f in the second main content period 350, like the last segment 312f in the first main content period 310, may contain a message instructing the client 320 to retrieve another updated MPD for another period that is to be inserted after the end of the second main content period 350. In this way, advertisements or other secondary content may be inserted into a content stream at appropriate times in the stream even when it is not known before the stream begins when those times will occur.

In some cases, different advertisements may be targeted to different clients. In such cases, an MPD may not include a fixed URL for a single advertisement that is to be played at a given time. In an embodiment, the link 334 in the updated MPD 330 to the content in the inserted period 340 may be dereferenced to different URLs at different times for different clients. The URLs may point to remote entities comprising different advertisements/content for different clients. In some embodiments, the link 334 in the updated MPD 330 may point to a remote entity that comprises a description of streamable content. For example, such a link may be an Extensible Markup Language (XML) Linking Language link, which may be referred to herein as an XLink For example, the client 320 may receive an updated MPD 330 comprising an Xlink, which may point to a description of content to be inserted into the content stream. The client 320 may dereference and/or resolve the link to obtain the description of the inserted content, and may include the description in the updated MPD 330. The client 320 may then employ the resolved description to obtain the inserted content as needed.

An XLink may be dereferenced or resolved according to either an OnLoad parameter or an OnRequest parameter. In OnLoad dereferencing, a client resolves an XLink at the time an MPD containing the XLink is loaded. In OnRequest dereferencing, also known as dynamic dereferencing, a client resolves an XLink at the time the client reads the portion of the MPD that contains the XLink. In FIG. 3, OnRequest dereferencing may be used. When the client 320 retrieves the updated MPD 330, it may not be clear when the OnRequest dereferencing of the XLink 334 is to occur. If the XLink is dereferenced too soon, the content to be played in the inserted period 340 may not yet be available for download. If the XLink is dereferenced too late, the content to be played in the inserted period 340 may not be retrieved in a timely manner.

In an embodiment, the timing is specified for OnRequest dereferencing of an XLink that references content in a period dynamically inserted between periods of main content. More specifically, Pm may be defined as a period carrying main content, and Pi may be defined as a period carrying inserted content immediately following Pm. T may be defined as the effective duration of period Pm (e.g. PeriodStart(Pi)−PeriodStart(Pm)). MBT may be defined as the minimum buffer time for the streaming system 300. In an embodiment, the segment 312f that contains the message instructing the client 320 to retrieve the updated MPD 330 is transmitted at a time T−2×MBT. In other words, the XLink 334 is dereferenced at a time twice the length of the minimum buffer time before the end of the first main content period 310.

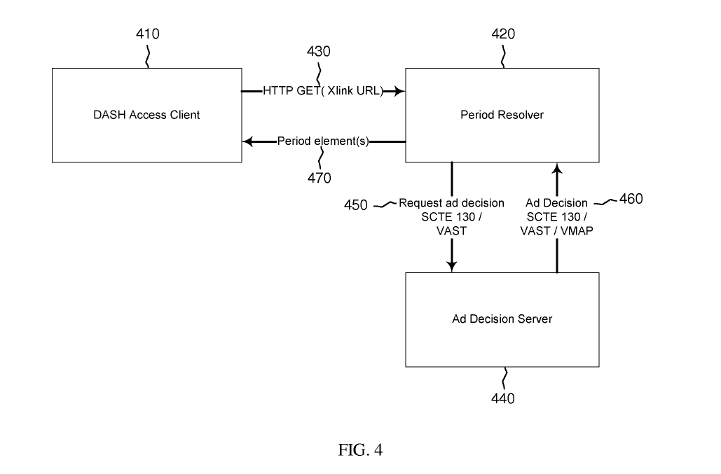

On-demand dereferencing of remote elements with an XLink may be used for targeted advertisement insertion and may require a real-time decision on advertisement content to be presented to a user. In an embodiment of advertisement insertion using DASH and remote period elements, the dereferencing system may function as illustrated in FIG. 4. In FIG. 4, a DASH access client 410 may dereference a remote element using an HTTP URL provided to the client 410 in a corresponding DASH MPD. In this context, the element may be assumed to be a period element, but any MPD element that has attributes @xlink:href and @xlink:actuate may be dereferenced according to the techniques disclosed herein.

As illustrated in FIG. 4, when a period resolver 420, e.g., an HTTP server, receives an HTTP GET request 430 from the DASH client 410, the period resolver 420 may contact an advertisement decision server 440. The period resolver 420 may send a request 450 for an advertisement decision to the advertisement decision server 440 utilizing one or more suitable communication protocols widely known in the art, e.g., Video Ad Serving Template (VAST) and/or Society of Cable Telecommunications Engineers (SCTE) standard 130, which are incorporated herein by reference. The advertisement decision server 440 may return an advertisement decision 460 to the period resolver 420. The advertisement decision server 440 may utilize one or more suitable communication protocols widely known in the art, e.g. VAST, SCTE 130, and/or Video Multiple Ad Playlist (VMAP) to return the advertisement decision 460 to the period resolver 420. The period resolver 420 may translate the advertisement decision 460 into one or more period elements 470. The period resolver 420 may then transmit the period elements 470 to the DASH client 410 in response to the original HTTP GET request 430 from the DASH client 410.

The DASH standard may not specify when dereferencing occurs. Certain values, e.g., the @xlink:actuate value OnLoad may require immediate dereferencing, while the value OnRequest may allow deferred dereferencing. In this disclosure, the OnRequest value will be considered when dereferencing is discussed.

The specification for XLink indicates that an application may traverse from the starting resource to the ending resource on a post-loading event triggered for the purpose of traversal. An example of such an event might be when a user clicks on the presentation of the starting resource, or a software module finishes a countdown that precedes a redirect. The specification may not provide guidance or compliance criteria, and thus it may be acceptable to dereference an element as early as the time when the MPD is parsed. This issue may be overcome through the use of dynamic MPDs and/or just-in-time MPD updates. The MPDs may be triggered early enough that the DASH client may have sufficient time to download the new MPD, parse the MPD, and dereference the remote elements contained in the MPD.

The use of dynamic MPDs and/or just-in-time MPD updates may provide a well-defined timing model. However, such a technique may require frequent MPD updates that may increase traffic overhead. Further, if DASH events are utilized, it may be necessary for the entity performing media segmentation to be aware of the advertisement insertion functionality. If the MPD Patch event is not utilized, additional delay may be incurred due to fetching an MPD. If the MPD Patch event is utilized, the delay associated with fetching an MPD may not be incurred, but a tight synchronization between the entity generating a MPD and the entity segmenting the media may result.

Defining an XLink timing model for DASH may address the above issues. Such a definition may entail that any DASH client that implements the original DASH specification be capable of operating correctly even if the client is unaware of the timing model. Such a solution may also entail that compatibility with XLink not be broken.

Element Availability Start Time (EAST) may be defined as the earliest time an element may be dereferenced, and MPD Parse Time (MPT) may be defined as the time at which an MPD is parsed. In an embodiment, a generic DASH client may dereference an element after EAST by returning remote elements any time a request is made prior to EAST. However, this procedure may lead to an infinite loop of requests from unaware clients. In an alternative embodiment, an HTTP status code, e.g., 3xx, 4xx, and/or 5xx, may be returned as a response to any dereferencing request made prior to EAST. An unaware client may reload an MPD on failure, so in an example of a 5xx error code, e.g., 504 Gateway Timeout, an aware client may back off and retry later. In such an example, an unaware client may interpret the error as an error invalidating the MPD, and thus a fetch of a new MPD and a re-parse may be called for. In an embodiment, in order to prevent an infinite loop with frequently occurring attempts to reload an MPD as a result of repeated failures to dereference before EAST, an HTTP server may delay the response.

It may be possible to signal EAST explicitly. Signaling EAST explicitly may require an additional optional attribute, e.g., @xlink:availabilityTime, that may be added to all DASH MPD elements that have the attribute @xlink:href. The semantics of @xlink:availabilityTime indicate that the URL specified in @xlink:href may not be resolved prior to the time specified in @xlink:availabilityTime. The @xlink:availabilityTime may be relative to the PeriodS tart time. An unaware client may attempt an earlier dereferencing, at which point a server-side method may be used to prevent the early dereferencing.

XLink 1.1 allows another value for @xlink:actuate known as other. The other value may indicate that the behavior of an application traversing to the ending resource is unconstrained by the XLink specification. In such a case, the application may look for one or more other markups present in the link to determine an appropriate behavior. An unaware client may ignore the value other, while an aware client may obey the rules specified in the DASH specification. The DASH standard may not allow the use of other, which may result in older MPD validators finding MPDs invalid if the validators utilize the other value. In an embodiment, to allow the use of other, the DASH profile of XLink may be modified. In a system where the @xlink:actuate value of other is used in conjunction with @xlink:availabilityTime, an aware client may dereference the element after EAST, while an unaware client may ignore the element as the unaware client may not recognize the required behavior.

In another embodiment, requirements for DASH client awareness may be expressed in an MPD as a profile, e.g., a profile Uniform Resource Identifier (URI). A DASH client complying with a profile in which client awareness requirements are expressed may obey the timing model disclosed herein.

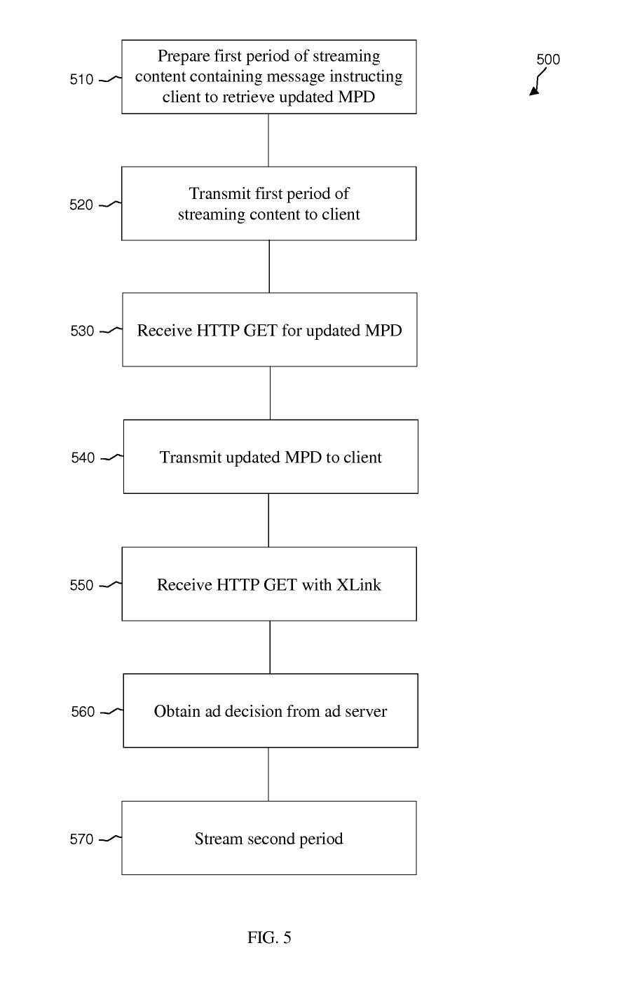

FIG. 5 is a flowchart illustrating an embodiment of a method 500 of data streaming in an adaptive streaming system. At block 510, a network element prepares a first period of streaming content containing a message instructing a client to retrieve an updated MPD. At block 520, the network element transmits the first period of streaming content to the client. At block 530, the network element or a component associated with the network element receives from the client an HTTP GET message or a similar message requesting the updated MPD. At block 540, the network element or the component associated with the network element transmits the updated MPD to the client. At block 550, the network element receives from the client an HTTP GET message or a similar message containing an XLink specifying a remote entity comprising content, such as an advertisement, to be played in a second period of streaming content (e.g. inserted into a content stream). At block 560, in the case where the content to be played in the second period is an advertisement, the network element obtains an advertisement decision from an advertisement server. At block 570, the network element streams the content of the second period to the client.

The following references are incorporated herein by reference as if reproduced in their entirety: ISO/IEC 23009-1:2012 Information technology—Dynamic adaptive streaming over HTTP (DASH)—Part 1: Media presentation description and segment formats; ISO/IEC 23009-1:2012/Cor 1:2013; XML Linking Language (XLink) Version 1.1, W3C Recommendation 6 May 2010; Alex Giladi (ed.), Ad Insertion in DASH: Architectures and Guidelines, Jul. 10, 2013; Giles Godart-Brown, Jeff Goldberg, Rolando Medina, Keith Millar, Advert Insertion using MPEG DASH, v1.0, May 15, 2013; and Ad Insertion in DASH, Architectures and Guidelines, May 9, 2014.

As discussed herein, the interoperability point for static just-in-time dereferencing assumes multi-period DASH content and an MPD that contains Period@xlink:href and Period@xlink:actuate. It may be a superset of Static Multiperiod Interoperability Points (IOP), with the addition of XLink The compliance to Static Just-in-time IOP may be signaled by an @profiles attribute with the value http://dashif.org/guidelines/adin/static#jit.

Regarding content authoring, an Assetldentifier descriptor may be used for distinguishing parts of the same asset within a multi-period MPD, hence it may be used for main content. In order to enable better tracking and reporting, unique Identifiers (IDs) may be used for different assets. Hence it is recommended to use Assetldentifier descriptors in inserted content as well. The value of @schemeldUri may be “urn:org:dashif:asset-id:2014”. The value of @value attribute descriptor may be a MovieLabs ContentID URN for the content. It may be the same for all parts of an asset. A preferred scheme may be Entertainment Identifier Registry (EIDR). If the period is the last period of a multi-period asset, the author may add a so-called one-off self-contained period (e.g., an advertisement), and the value of the AssetIdentifier@id attribute may be a universally unique identifier (UUID). If the latter actions are not taken, the random access logic for a repeated ad may consider every repeated appearance of the ad as a continuation of its previous appearance(s). This way, a second appearance of an ad may have a playout bar start at 50 percent. The Assetldentifier descriptor may be used for all multi-period assets. If a period has single-period semantics (i.e., an asset is completely contained in a single period and its continuation is not expected in the future), the author may not use asset identifier on these assets. Periods that do not contain non-remote AdaptationSet elements, as well as zero-length periods, may not contain the AssetIdentifier descriptor.

Regarding period continuity, ad content may be DASH-Advanced Video Coding (AVC)/264 compliant content. Content in different periods with the same AssetIdentifier may be conditioned in a way that preserves content characteristics (e.g. codecs, resolutions, frame rates, bitrates). It may be desirable to have same initialization segment and have maximum commonality of Digital Rights Management (DRM) information. Inserted content may be conditioned in a way that allows seamlessness of period transition—e.g., changes in codecs, resolutions, frame rates, etc. are discouraged. Moreover, lowest bitrate of the inserted content may never be higher than the lowest bitrate of the main content.

Regarding on demand content, in case the main content complies with ISO-BMFF On Demand profile, it may be assumed that the content is stored as a single file. There may be no need to create per-period files if this content is offered as multi-period. All periods for this asset may have same BaseURL values and different SegmentBase@presentationTimeOffset values, each corresponding to the media time equivalent to PeriodStart. The file may contain ‘sidx’ box(es), and the client may read the index information to calculate the segment offsets taking the value of SegmentBase@presentationTimeOffset into account.

An MPD may contain remote periods, some of which may have default content, and some of which may be resolved into multiple Period elements. After dereferencing, MPD may contain zero-length periods or/and remote periods. In case of Period@xlink:actuate=“onRequest”, MPD update and XLink resolution may be done sufficiently early to ensure that there are no artefacts due to insufficient time given to download of the inserted content. Let Pm be the period carrying main content, and Pi−remote period carrying inserted content immediately following it. Let the effective duration of period Pm (i.e., PeriodStart(Pi)−PeriodStart(Pm)) be T. Also, let MBT be MPD@minBufferTime. Dereferencing Pi should be done at time T−2×MBT. If there is no response by T−1×MBT, the client may assume that dereferencing failed.

The interoperability point for dynamic multi-period dereferencing is an extension of the static multi-period discussed above, with the difference that the content relies on DASH MPD Validity Expiration events to trigger MPD updates once the upstream equipment (e.g. packager) detects an incoming cue. The compliance to Static Just-in-time TOP may be signaled by a @profiles attribute with the value http://dashif.org/guidelines/adin/dynamic#multiperiod.

The guidelines discussed above for content authoring in the static dereferencing case may apply to dynamic multi-period dereferencing also. DASH MPD Validity Expiration may be expected to occur in some of the media segments.

Presence of inband MPD Validity Expiration events may be signaled using AdaptationSet.InbandEventStream element with @schemeldUri=”urn:mpeg:dash:event:2012”. Inband MPD Validity expiration events may be present in video. If these events are used, video adaptation sets may carry them.

‘emsg’ boxes may be aligned if segment SR1(i) is the ith segment of a representation R1 within an adaptation set containing N representations, then if SR0(i) contains an ‘emsg’ box, identical ‘emsg’ box will be carried in segments SR2(i) . . . , SRN(i). This means that irrespective of representation selected, all ‘emsg’ boxes may be read if media from an adaptation set is played out. At most one ‘emsg’ box may be present in a segment. If several ‘emsg’ boxes are present in a segment, ‘emsg’ may appear first.

Regarding timing behavior, let Pm be the period carrying main content, and Pi—period carrying inserted content immediately following it. Let the effective duration of period Pm (i.e., PeriodStart(Pi)−PeriodStart(Pm)) be T. Also, let MBT be MPD@minBufferTime. The ‘emsg’ carrying MPD Validity Expiration event that triggers MPD update that adds period Pi should be carried in a segment with event period time (EPT)≦T−2×MBT.

The interoperability point for dynamic just-in-time dereferencing may be a combination of Dynamic Multiperiod TOP and Static Just-in-time TOP. MPD may contain remote Period elements (e.g., Period@xlink:href and Period@xlink:actuate may be present), and MPD updates may be triggered by MPD Validity Expiration events. The compliance to Dynamic Just-in-time TOP may be signaled by a @profiles attribute with the value “http://dashiforg/guidelines/adin/dynamict it”.

The guidelines discussed above for content authoring in the static dereferencing case and the dynamic multi-period dereferencing case may apply to dynamic just-in-time dereferencing also. Care may need to be taken so that the client is given a sufficient amount of time to (a) request and receive MPD update, and (b) dereference the upcoming remote period.

In case of Period@xlink:actuate=“onRequest”, following dereferencing—when done at most 2×MBT seconds before the PeriodStart—the first resulting Period may be a valid period (e.g. not require an extra round of dereferencing). If the remote element entity contains more than one Period element, these may be remote elements.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 7 percent, . . . , 70 percent, 71 percent, 72 percent, . . . , 97 percent, 96 percent, 97 percent, 98 percent, 99 percent, or 100 percent. Moreover, any numerical range defined by two R numbers as defined in the above is also specifically disclosed. The use of the term “about” means 10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method of content streaming in a system implementing Dynamic Adaptive Streaming over Hypertext Transfer Protocol (HTTP) (DASH), the method comprising:
preparing, by a system element, a first period of streaming content containing a message signaling existence of an updated media presentation description (MPD);
transmitting the first period of streaming content to a client; and
after transmitting the message via the first period of streaming content, transmitting the updated MPD to the client.

2. The method of claim 1, wherein the first period comprises a plurality of segments, and wherein the method further comprises placing the message in a last segment transmitted in the first period of streaming content.

3. The method of claim 1, further comprising placing in the message an indicator indicating a location from which the updated MPD is available.

4. The method of claim 1, wherein the updated MPD includes a description of content in a second period of streaming content not described in an MPD previously available to the client.

5. The method of claim 4, wherein the updated MPD indicates that the second period of streaming content is to begin substantially immediately after the end of the transmission of the first period of streaming content.

6. The method of claim 4, wherein the updated MPD includes a link referencing a remote entity that comprises a description of the second period of content to be dynamically inserted into a content stream to the client.

7. The method of claim 6, wherein the link is an Extensible Markup Language (XML) Linking Language (XLink) link.

8. The method of claim 7, wherein the XLink link is dereferenced at a time before an end of the first period of streaming content.

9. A method of dereferencing by a client in a system implementing Dynamic Adaptive Streaming over Hypertext Transfer Protocol (HTTP) (DASH), the method comprising:
receiving a first period of streaming content containing a message instructing the client to retrieve an updated media presentation description (MPD) and containing an indicator indicating a location from which the client is to retrieve the updated MPD;
retrieving the updated MPD; and
dereferencing a link in the updated MPD,
wherein the link references a remote entity that comprises a description of a second period of streaming content to be dynamically inserted into a content stream to the client, and
wherein the client performs the dereferencing at a time before an end of the first period of streaming content.

10. The method of claim 9, wherein the link is an Extensible Markup Language (XML) Linking Language (XLink) link.

11. The method of claim 9, further comprising receiving an initial MPD prior to the updated MPD, wherein the second period of streaming content described in the updated MPD is not described in the initial MPD.

12. The method of claim 9, wherein the updated MPD indicates that the second period of streaming content is to begin substantially immediately after the end of the first period of streaming content.

13. A method of performing dynamic just-in-time dereferencing of a link to adaptive streaming content, the method comprising:
following a combination of dynamic multi-period dereferencing procedures and static just-in-time dereferencing procedures,
wherein a media presentation description (MPD) describing the content contains remote period elements,
wherein an update of the MPD is triggered by a MPD Validity Expiration event, and
wherein compliance with the dynamic just-in-time dereferencing is signaled by a @profiles attribute.

14. The method of claim 13, wherein, when Period@xlink:actuate=“onRequest”, and when dereferencing is done at most 2×MPD@minBufferTime (MBT) seconds before a PeriodStart, a first resulting Period is a valid period, and wherein, when a remote element entity contains more than one Period element, the Period elements are remote elements.

15. The method of claim 13, wherein the MPD contains remote periods, some of which have default content and some of which are resolved into multiple Period elements, and wherein, when Period @xlink:actuate=“onRequest”, an MPD update and an XLink resolution are completed prior a PeriodStart to prevent errors due to insufficient time given to a download of inserted content.

16. The method of claim 15, wherein Pm is a period carrying main content, Pi is a remote period carrying inserted content immediately following Pm, T is an effective duration of period Pm=PeriodStart(Pi)−PeriodStart(Pm), and MBT is MPD@minBufferTime, and wherein dereferencing of Pi is done at time T−2×MBT.

17. The method of claim 16, wherein dereferencing has failed when there is no response by T−1×MBT.

18. The method of claim 13, wherein presence of an inband MPD Validity Expiration event is signaled using AdaptationSet.InbandEventStream element with @schemeldUri=”urn:mpeg:dash:event:2012”.

19. The method of claim 13, wherein ‘emsg’ boxes are aligned such that if segment SR1(i) is the ith segment of a representation R1 within an adaptation set containing N representations, wherein when SR0(i) contains an ‘emsg’ box, an ‘emsg’ box is also carried in segment SRN(i), wherein, irrespective of a representation selected, all ‘emsg’ boxes are read if media from an adaptation set is played out, and wherein at most one ‘emsg’ box is present in a segment.

20. The method of claim 13, wherein an Asseddentifier descriptor is used for distinguishing parts of the same asset within a multi-period MPD, and wherein unique Identifiers (IDs) are used for different assets.
